(19) United States
(12) Patent Application Publication
(10) Pub. No.: US 2006/0147797 A1
(43) Pub. Date: Jul. 6, 2006

(54) Anode materials of lithium secondary battery and method of fabricating the same

(75) Inventors: Hung-Chun Wu, Changhua County (TW); Mo-Hua Yang, Hsinchu City (TW); Nae-Lih Wu, Taipei County (TW); Wei-Ren Liu, Taoyuan County (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/186,850

(22) Filed: Jul. 22, 2005

(30) Foreign Application Priority Data
Dec. 31, 2004 (TW) 93141873

(51) Int. Cl. H01M 4/58; B05D 5/12; H01M 4/48

(52) U.S. Cl. 429/218.1; 429/231.95; 429/231.8; 427/126.3; 429/231.5

(57) ABSTRACT

An anode material of a lithium secondary battery. The anode material includes a plurality of silicon particles, each silicon particle comprising a silicon core covered by a coating layer containing at least one metal oxide, preferably TiO₂, ZrO₂, or a combination thereof. The invention also provides a method of fabricating the anode material using chemical vapor deposition or sol-gel process.

### BACKGROUND

The present invention relates to a lithium secondary battery, and more specifically to an anode material based on silicon of a lithium secondary battery and a method of fabricating the same.

A lithium secondary battery is defined as a lithium battery capable of charge and discharge. Currently, graphite is a popular anode material. Silicon material, however, has a theoretical capacity of about 4000 mAh/g, much larger than graphite's 372 mAh/g. Thus, silicon has great potential as an anode material in lithium secondary batteries.

Nevertheless, silicon material has yet to be applied in lithium secondary batteries due to its larger volume variation (by 300%) during charge and discharge, low conductivity, unstable solid electrolyte interface (SEI), low electrochemical reactivity, and high resistance in electrode plate interface.

Due to the above drawbacks, capacity of a lithium secondary battery utilizing silicon as anode may be dramatically decreased after merely ten cycles. Recently, methods for improving electrochemical performance of silicon anode materials have been disclosed.

In U.S. Pat. No. 6,649,033, Sanyo Cooperation discloses a silicon thin film deposited on copper foil by using the combination of sputtering and vapor deposition to a thickness of about 2˜5 μm, substituting for a conventional slurry coating process (30˜80 μm). This method provides a capacity of 3000 mAh/g and several hundred cycles. Nevertheless, the low-pressure vacuum sputtering process has a much higher process cost than slurry coating.

In U.S. Pat. No. 6,548,208, Matsushita Cooperation discloses an alloy with matrix structure of metal and silicon formed in a high temperature melting process to stabilize anode material structure during charge and discharge. The matrix structure may reduce silicon volume expansion caused by lithium insertion/extraction.

As disclosed in EP 1024544A2 by Mitsui Mining Co., Ltd., a carbon layer was coated on silicon powder surface by thermal vapor deposition. The particle size of the silicon powder is about 0.1˜50 μm and the carbon content of is 5 wt %. The coating was performed with a fluidized bed at 900° C. The carbon layer was a graphitized material and had sufficient strength to inhibit silicon expansion. Charge voltage was about 0.05˜0.08V and stable repeating capacity exceeded 900 mAh/g.

Anode materials of a lithium secondary battery provided by the invention are based on silicon. Nevertheless, the present anode materials and their fabrications are totally different from conventional devices.

### SUMMARY

The invention provides an anode material of a lithium secondary battery comprising a plurality of silicon particles, wherein each silicon particle comprises a silicon core covered by a coating layer containing at least one metal oxide. The metal oxide comprises TiO₂, ZrO₂, or a combination thereof. The coating layer has a thickness of about 1˜1000 nm and comprises a single or multiple layers. The silicon core has a diameter less than 100 μm. The invention provides a silicon anode material with a capacity exceeding 1000 mAh/g. A metal oxide layer may act as a lithium channel, improving uniformity of lithium distribution, and as an artificial solid electrolyte interface (SEI).

The invention also provides a method of fabricating an anode material of a lithium secondary battery with chemical vapor deposition.

The invention further provides a method of fabricating an anode material of a lithium secondary battery with a sol-gel process.

The invention also discloses electrochemical characteristic tests of a lithium secondary battery, clearly illustrating advantages thereof.

Anode materials of a lithium secondary battery provided by the invention are based on silicon.

The invention provides a silicon material with high theoretical capacity to improve electrical performance of a lithium secondary battery.

The invention solves problems regarding related applications of silicon materials in an anode of a lithium secondary battery.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an anode material of a lithium secondary battery of the invention.

FIG. 2 is a flowchart of fabrication of an anode material of the invention by chemical vapor deposition.

FIG. 3 shows X-ray diffraction of an anode material in the example of FIG. 2.

FIG. 4 is a flowchart of another method of fabricating an anode material of the invention by sol-gel process.

FIG. 5 shows X-ray diffraction of an anode material in the example of FIG. 4.

FIG. 6 shows the discharge capacity as the function of cycle numbers in a comparative example.

FIG. 7A shows a relationship between capacity and voltage of a Si—ZrO₂ material during the first charge and discharge.

FIG. 7B shows a relationship between capacity and voltage of a Si—TiO₂ material during the first charge and discharge.

FIG. 8 shows the charge and discharge capacity as the function of cycle numbers in another comparative example.

### DETAILED DESCRIPTION

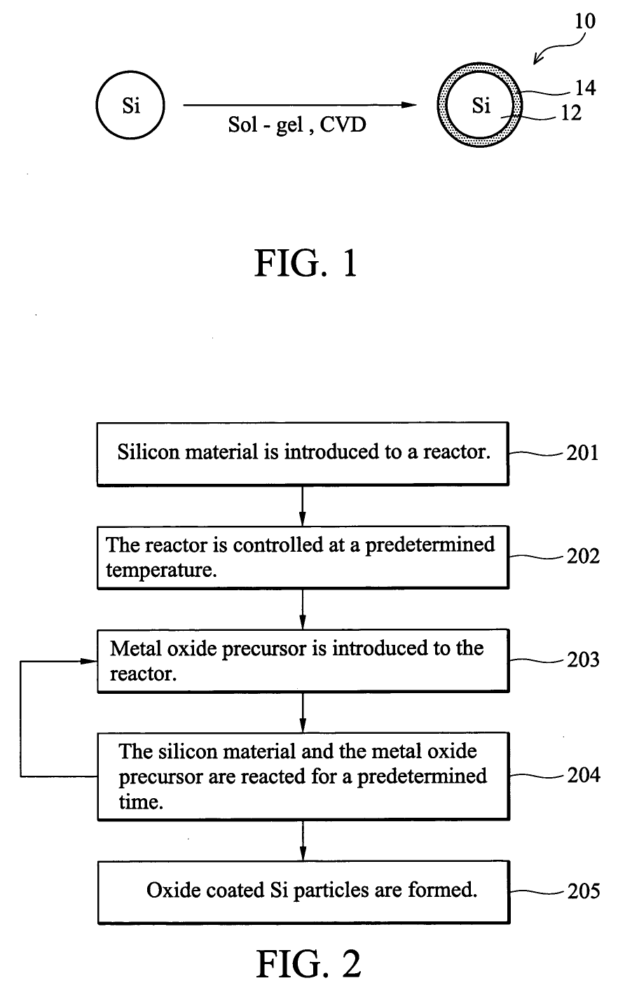

Referring to FIG. 1, illustrating an anode material of a lithium secondary battery of the invention, the anode material comprises a plurality of silicon particles 10. Each silicon particle 10 comprises a silicon core 12 covered by a coating layer 14 containing at least one metal oxide. The metal oxide comprises TiO₂, ZrO₂, or a combination thereof. The coating layer 14 has a thickness of about 1-1000 nm.

The silicon core 12 has a diameter less than 100 μm. The coating layer 14 may be a single or multiple layers formed by numerous coating steps. In addition to TiO₂ or ZrO₂, the multiple layers may further comprise graphite or carbon layers. The metal oxide, such as TiO₂ or ZrO₂, has a weight percentage of about 0.01˜100% in the coating layer 14.

The invention provides a silicon material (silicon core 12) with a theoretical capacity exceeding 4000 mAh/g as a main material of an anode of a lithium secondary battery and a metal oxide, such as TiO₂ or ZrO₂, to increase cycle life of the silicon core 12. Accordingly, uniformity of lithium distribution may be improved. The coating layer may be used as an artificial solid electrolyte interface (SEI).

### EXAMPLES

### Example 1

Referring to FIG. 2, a method of fabricating an anode material of a lithium secondary battery is disclosed as follows. In this example, a silicon particle 10 comprising a coating layer 14 containing a metal oxide was prepared by chemical vapor deposition.

10 g silicon powders were introduced to a fluidized bed reactor by pulse-fluidization with application of 1 Hz pulse frequency and carrier gases. The carrier gases had a flow rate of 2 l/min and comprised 3% H₂ and 97% N₂.

After one hour, a titanium isopropoxide solution, as a TiO₂ precursor, was introduced to the fluidized bed reactor through these carrier gases.

The anode material was prepared at 800° C. The anode material comprised a plurality of silicon particles 10 as shown in FIG. 1. In each silicon particle 10, a silicon core 12 had a diameter less than 100 μm and a coating layer was a single TiO₂-containing layer.

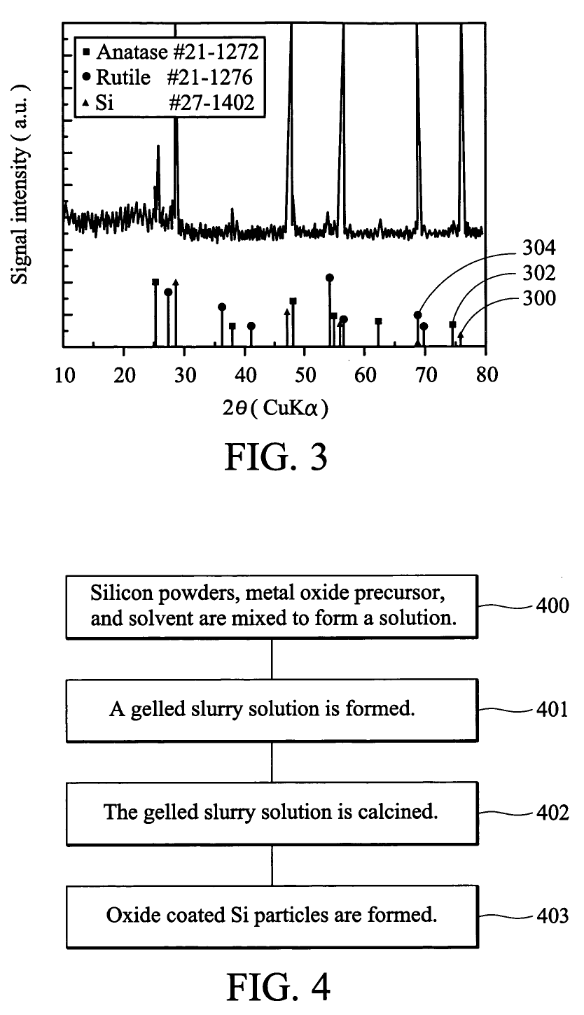

Referring to FIG. 3, in which illustrates X-ray diffraction of the anode material in this example, the target material was CuK α (1.5418 Å) and scan rate was 5 deg./min. The results indicate that the anode material is a crystalline TiO₂-containing particle 10 and TiO₂ uniformly covers the surface of the silicon core 12.

Multiple ZrO₂-containing coating layers 14 were prepared by numerous coating, repeating steps 203 and 204 illustrated in FIG. 2. Zirconium tert-butoxide was used as a precursor of ZrO₂.

A single ZrO₂-containing coating layer 14 may be formed on the surface of the silicon core 12.

Multiple coating layers 14 containing various metal oxides were prepared by coating, using various metal oxide precursors such as titanium isopropoxide and Zirconium tert-butoxide in step 203, or coating by carbon. The resulting multiple coating layers 14 comprise TiO₂, ZrO₂, or carbon.

### Example 2

Referring to FIG. 4, another method of fabricating an anode material of a lithium secondary battery is disclosed. In this example, a silicon particle 10 comprising a coating layer 14 containing a metal oxide was prepared by a sol-gel process.

2.35 g metal oxide precursor, Zirconium tert-butoxide, was added to 9.4 g n-butanol at a ratio of 4:1 and stirred for 15 min to form a yellow clear metal oxide precursor solution.

Pre-dried silicon powders were then mixed with the metal oxide precursor solution to form a solution as shown in step 400.

The solution was then stirred to increase permeability of the metal oxide precursor solution into pores of the silicon material. To improve adhesion of metal oxide, air was extracted from pores of the silicon material.

Next, the solution was heated on a hot plate with oil bath and stirring to increase viscosity thereof. A gel solution was then prepared in step 401.

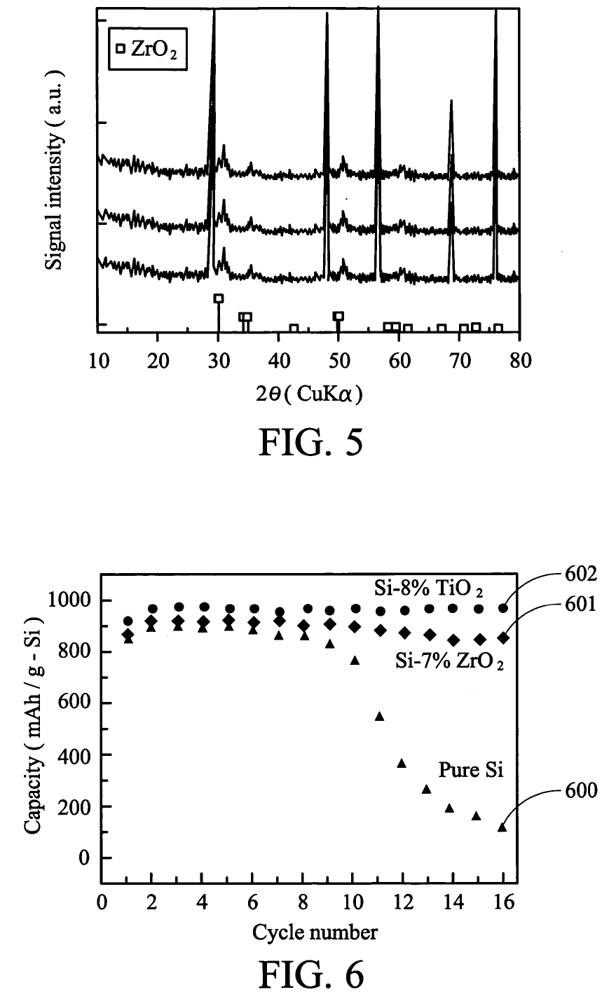

Next, the gel solution was calcined (step 402) to form anode material powders of a lithium secondary battery in step 403. The calcining was performed as follows. The gel solution was placed in a furnace. The furnace was heated to 700° C. at a heating speed of 50° C./hr and maintained at that temperature for 6 hours. After cooling to room temperature, powders were ground and sieved with 270 mesh to form an anode material of a lithium secondary battery. The anode material comprised a plurality of silicon particles 10 and was a Si—ZrO₂ composite material. Referring to FIG. 5, which illustrates X-ray diffraction of the anode material, the target material was CuK α (1.5418 Å) and scan rate was 5 deg./min.

Reactions of the sol-gel process are illustrated in the following.
Zr(OR)₄+H₂O→Zr(OR)₃(OH)+ROH
SiOH+Zr(OR)₃(OH)→SiOZr(OR)₃+H₂O

As well as the ZrO₂-containing coating layer 14, the invention also provides a TiO₂-containing coating layer 14 covering the surface of the silicon core 12.

The TiO₂ precursor comprises titanium alkoxide or a salt of titanium, and the ZrO₂ precursor comprises zirconium alkoxide or a salt of zirconium.

In the sol-gel process, the metal oxide precursor solution comprises a solvent of H₂O or CxHyOHz, wherein x is about 1-10, y is about 1-20, and z is about 1-10.

Referring to FIG. 6, in which illustrates a relationship between cycle life and capacity, three anode materials were provided to assemble half-cells (CR-2032) and tested. Initial capacity was 1000 mAh/g, current was 0.3 mA/mg, and voltage window was between 0 to 1.2V. The three anode materials were pure-Si (600), Si—ZrO₂ (ZrO₂-coated Si)(601), and Si—TiO₂ (TiO₂-coated Si) (602), respectively.

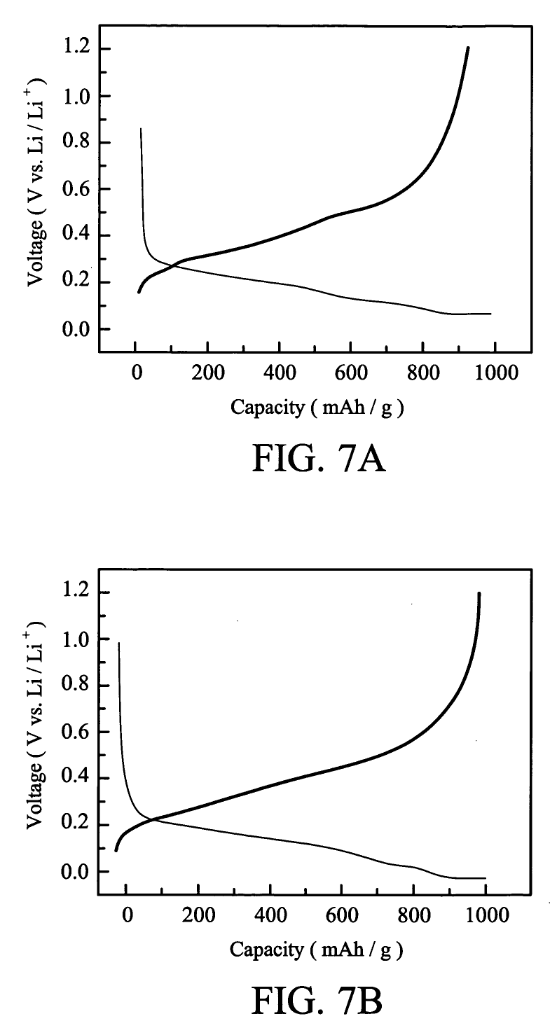

Referring to FIGS. 7A and 7B, in which illustrate relationships between capacity and voltage of Si—ZrO₂ and Si—TiO₂ materials during the first charge and discharge, electrical characteristics were clearly acquired.

In FIG. 6, pure-Si material (600) represented lower cycle stability during charge and discharge. Capacity dramatically decreased after merely five cycles. Silicon volume is violently expanded with lithium insertion, resulting in cracked electrode plates and worsened contact between the silicon material and copper foil. Thus, electrons cannot be ejected from the copper foil (current collector) during charge and discharge. Compared to the pure-Si material, the Si—ZrO₂ or Si—TiO₂ anode material of the invention provides longer lifetime during charge and discharge.

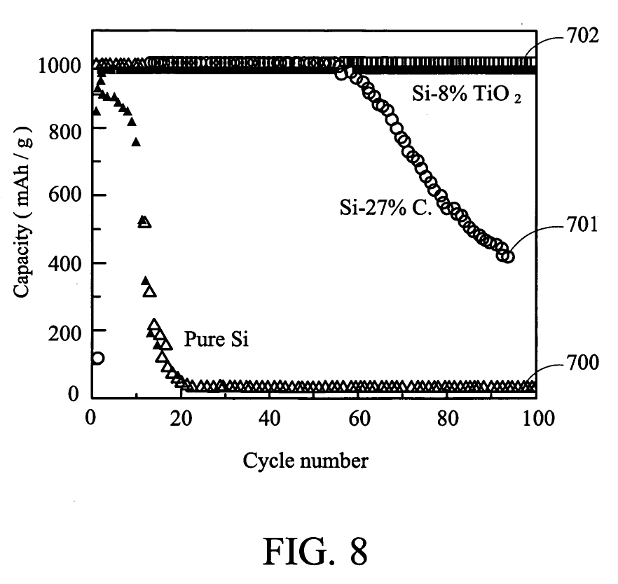

Referring to FIG. 8, in which illustrates relationships between cycles during charge and discharge and capacities, the anode materials provided by the invention and Mitsui Mining Cooperation (EP No. 1,024,544) were compared. Half-cells were assembled using Si—TiO₂ (702), Si-Carbon (701), and pure-Si (700) materials and tested, respectively. Initial capacity was 1000 mAh/g, current was 0.3 mA/mg, and voltage window was between 0 to 1.2V (V vs. Li/Li⁺)

The results indicate that the Si—TiO₂ (702) composite material providses the longest cycle life during charge and discharge. The Si-Carbon composite material, however, has a longer cycle life than the pure-Si material due to its stable structure formed by adding carbon atoms. Additionally, the invention provides a coating layer containing less metal oxide, merely 8%. Related art (EP No. 1,024,544), however, needs to provide at least 27% carbon elements therein. Thus, thinner coating layer 14 can also provide longer cycle life.

The invention provides an anode material based on silicon of a lithium secondary battery comprising a plurality of silicon particles. Each silicon particle comprises a silicon core and a coating layer containing at least one metal oxide covering the silicon core. The metal oxide is preferably titanium oxide, zirconium oxide, or a combination thereof. The anode material of the invention is prepared by chemical vapor deposition or a sol-gel process. The invention overcomes problems regarding related applications of silicon materials in a lithium secondary battery and utilizes high theoretical capacity of silicon, acquiring longer cycle life.

While the invention has been described by way of example and in terms of preferred embodiment, it is to be understood that the invention is not limited thereto. To the contrary, it is intended to cover various modifications and similar arrangements. For example, those who are skilled in this technique are able to add the carbon to the oxide coating layer in order to adjust the electronic conductivity of the whole coating layer. For instance, another example of this invention shows the silicon 12 is reacted with the carrier gas which contains the Titanium isopropoxide and benzene at 800° C. by pulse-flow CVD method. The single coating layer 14 which contains TiO2 and carbon is formed on the surface of the silicon 12 after the coating. Therefore, the scope of the appended claims should be accorded the broadest interpretation so as to encompass all such modifications and similar arrangements.

What is claimed is:

1. An anode material of a lithium secondary battery, comprising a plurality of silicon particles, each silicon particle comprising a silicon core covered by a coating layer containing at least one metal oxide.

2. The anode material of a lithium secondary battery as claimed in claim 1, wherein the coating layer is a single layer.

3. The anode material of a lithium secondary battery as claimed in claim 1, wherein the coating layer comprises multiple layers.

4. The anode material of a lithium secondary battery as claimed in claim 1, wherein the coating layer has a thickness of about 1-1000 nm.

5. The anode material of a lithium secondary battery as claimed in claim 1, wherein the metal oxide comprises titanium oxide (TiO₂), zirconium oxide (ZrO₂), or a combination thereof.

6. The anode material of a lithium secondary battery as claimed in claim 1, wherein the coating layer contains carbon.

7. The anode material of a lithium secondary battery as claimed in claim 1, wherein the metal oxide has a weight percentage of about 0.01-100% in the coating layer.

8. The anode material of a lithium secondary battery as claimed in claim 1, wherein the silicon core has a diameter less than 100 μm.

9. A method of fabricating an anode material of a lithium secondary battery, comprising:
providing a silicon material to a reactor;
controlling the reactor at a predetermined temperature; and
providing a metal oxide precursor to the reactor by pulse-flow chemical vapor deposition to form an anode material of a lithium secondary battery comprising a plurality of silicon particles, each comprising a silicon core covered by a coating layer containing at least one metal oxide.

10. The method as claimed in claim 9, wherein the predetermined temperature is about 300˜1000° C.

11. The method as claimed in claim 9, wherein the pulse-flow chemical vapor deposition has a pulse frequency of about 0.110 Hz.

12. The method as claimed in claim 9, wherein the metal oxide precursor comprises a titanium oxide precursor, a zirconium oxide precursor, or a combination thereof.

13. The method as claimed in claim 12, wherein the titanium precursor comprises titanium alkoxide or a salt of titanium.

14. The method as claimed in claim 12, wherein the zirconium precursor comprises zirconium alkoxide or a salt of zirconium.

15. A method of fabricating an anode material of a lithium secondary battery with a sol-gel process, comprising:
adding silicon powder to a metal oxide precursor solution;
gelling the resulting solution; and
calcining the gelled solution to form powder of an anode material of a lithium secondary battery comprising a plurality of silicon particles, each comprising a silicon core covered by a coating layer containing at least one metal oxide.

16. The method as claimed in claim 15, wherein the metal oxide precursor comprises a titanium precursor, a zirconium precursor, or a combination thereof.

17. The method as claimed in claim 16, wherein the titanium precursor comprises titanium alkoxide or a salt of titanium.

18. The method as claimed in claim 16, wherein the zirconium precursor comprises zirconium alkoxide or a salt of zirconium.

19. The method as claimed in claim 15, wherein the metal oxide precursor solution comprises a solvent of H₂O or CxHyOHz of x about 1˜10, y about 1˜20, and z about 1-10.

20. The method as claimed in claim 15, further comprising extracting air from the silicon powders before the gelled solution is formed.
